(19) United States
(12) Patent Application Publication
(10) Pub. No.: US 2018/0247617 A1
(43) Pub. Date: Aug. 30, 2018

(54) Movable tone amplifier for banjos

(71) Applicant: John F. Geiger, Sandy Springs, GA (US)

(72) Inventor: John F. Geiger, Sandy Springs, GA (US)

(21) Appl. No.: 15/732,395

(22) Filed: Nov. 6, 2017

Related U.S. Application Data
(60) Provisional application No. 62/600,495, filed on Feb. 24, 2017.

(51) Int. Cl. G10D 3/02

(52) U.S. Cl. CPC G10D 3/02; G10D 1/10

(57) ABSTRACT

A non-electronic device which extracts energy otherwise lost in a banjo's body and converts it into audible sound that not only adds volume to the sound coming from the head, but also makes the sound waves' high frequency components more pronounced. Readily movable from one attachment site to the next along the inside surface of the banjo's cylindrical rim, the device includes a two-dimensional, made-from-cardstock body and, affixed thereto along one end, an elongated strip of acrylic adhesive tape. Suspended from it within the banjo pot, the body routes sound surface waves coming from the rim to various surface wave-amplifying elements including an asymmetrical array of branches and tiny offshoots extending from them, as well as a pair of staples fastened to one branch and a five-sided, irregular timbre polygon hingedly connected to another branch so as to form, with it, a tiny loudspeaker.

### CROSS REFERENCE TO RELATED APPLICATION

This application is a non-provisional application of the earlier filed provisional application Ser. No. 62/600,495 filed Feb. 24, 2017, and claims the benefit of the priority date of the filing date Feb. 24, 2017, pursuant to U.S.C. Section 119(e).

### FIELD OF THE INVENTION

The present invention relates generally to banjos, and in particular to non-electronic devices for enriching and amplifying the sound output of banjos, with the devices being attached thereto during use but readily movable from one attachment site to the next, as well as transferable from one banjo to another.

### BACKGROUND OF THE INVENTION

When any musical instrument is played, all of its surfaces undergo minute, transient deformations. These physical deformations, like waves on a lake, cannot be heard because our ears can only hear air pressure waves, not surface deformations. Left without a suitable pathway into the instrument's sound chamber and, specifically, without such a pathway along which these very low intensity waves, each made up of a plurality of different frequencies, can be amplified, they remain unable to move adjacent air masses sufficiently to be heard, only to dissipate inaudibly.

As those skilled in the art of making music with stringed instruments such as banjos are well aware, each such instrument's sound quality is largely determined by the presence of harmonics, i.e., frequency multiples of each musical note's primary or base frequency sounding with it. In the parlance of performing musicians, the harmonics of a note add “depth” and “pleasantness” to its sound. Indeed, as taught by Geiger in U.S. Pat. No. 7,145,064, a note's “pleasantness” is noticeably enhanced, even when the instrument generating the note is being played anywhere within its full range of volume levels, provided the note's first several harmonics are present at a high energy level in the sound.

Unlike the banjo, other stringed instruments utilize the edges of the instrument's sound opening(s), to amplify inaudible sound surface waves. There they undergo constructive interference and form active vibration centers, spatially distinguishable from each other by virtue of differences in the strength of the very fast vibrations—that is, the precursors of the harmonics—which happen to concentrate to a greater degree at certain sites along such an edge rather than at others. Many of a banjo's sound surface waves, on the other hand, travel in great numbers in a generally spatially uniform, circular path around the inside surface of the banjo's cylindrical wood or aluminum rim.

Ignoring this critical difference, each prior art device for enriching and amplifying the sound output of stringed instruments non-electronically deploys a fastener or, alternately, a clamping means which must be secured, under tension, to the instrument itself. Only by releasing this tension can one reposition the device, multiple times if need be, and take advantage of spatial differences in the strength of an instrument's inaudible sound surface waves. Unfortunately, this approach is unduly cumbersome when the sound enhancing device is to be held within a banjo's pot and there capture a significant quantity of the banjo's sound surface waves as they circle around on the inside surface of the banjo's rim.

Moreover, when the fastener, as in the case of the banjo pot-mounted, sound enhancing device taught by Geiger in U.S. Pat. No. 7,145,064, is a steel or brass bolt, the sound surface waves-which are fed into it come not only from the banjo's rim, but also from a large assembly of metal parts. Indeed, this assembly includes the banjo's “shoe” bracket(s), nut(s), hook(s), flange, tone ring, and the metal hoop which pulls down on the banjo's plastic or vellum head—the totality of metal parts on the banjo's pot which are in metal-to-metal contact with this bolt either directly or indirectly.

Theorizing that a banjo's “wooden” sounds contribute disproportionately to the overall quality of the instrument's sound, but aware they cannot be captured independently of the “metallic” sounds with the use of this prior art device, the applicant saw a need for a novel tone amplifier which one can install within the banjo's pot in such a way that this amplifier, during use, remains isolated from any metal-to-metal contact either directly or indirectly with the metal parts on the banjo's pot and, at the same time, collects a substantial portion of the sound surface waves from the inside of the banjo's wood rim.

This novel approach to coaxing extra energy out of the banjo and converting it to audible sound waves has subsequently been proven to work, with surprising results and without exception, on a wide variety of banjos. Indeed, testing has revealed that the banjos within which the tone amplifier according to the present invention has been properly installed really do sound different, and that this difference is due, in large part, to the fact that the higher notes are louder than they otherwise would be. Related effects, also observed, vary from one banjo to the next. They include more pronounced increases in the volume of certain strings which, prior to the tone amplifier's installation, were less prominent in a particular banjo. And such effects include noticeable increases in the volume of several specific notes throughout yet another tone amplifier-equipped banjo's fingerboard, with the instrument involved being one in which these specific notes were previously dubbed “weak”.

### SUMMARY OF THE INVENTION

The object of the present invention is to provide a very simple, inexpensive device, temporarily attachable to a banjo's wood rim with the use of removable tape or the like, which, when properly installed, greatly improves the banjo's volume and sound quality.

A further object of the invention is to provide such a device which, when it is attached to the banjo's wood rim, can be held within the banjo's pot in such a way that, during use, the device remains isolated from any metal-to-metal contact either directly or indirectly with metal parts on the banjo itself.

A still further object of the invention is to provide such a device that can be used to change the tone “color”, or timbre, of the sound produced by the banjo by simply substituting or stacking at least one very thin piece of material which not only belongs to the group which includes brass, steel and maple, but also is of such a shape and size that one can align it, along all but one of its edges, with certain contiguous peripheral segments bounding the device's very lightweight main body, in preparation for creating a tiny loudspeaker by taping the thin piece's edge,.not included in the alignment with said peripheral segments, to the main body.

A yet further object of the present invention is to provide such a thin piece in the shape of a five-sided polygon having sides of non-equal lengths which, in use, increase the amplication of the sound surface waves reflected from the thin piece's edges as well as that of the audible sound which the tiny loudspeaker produces, to a degree far in excess of that which such a thin piece in the shape of a rectangle or regular polygon would yield.

Adapted for use with banjos in which the cylindrical rim that encircles the instrument's sound chamber is made of wood, an improved sound-enhancing device includes a thick piece of paper with variegated first and second branches, a thin strip of metal in the shape of an irregular polygon hingedly connected to the first branch, a pair of staples fastened to the second branch, and means for temporarily suspending the thick piece of paper from portions of the rim's inside surface which are disposed generally uppermost when the banjo is being held in its playing position by a musician, seated or standing.

In addition, the piece of thick paper defines an elongated main stem and, disposed on opposite sides thereof, a pair of three-sided arms, with the main stem being formed integrally not only with these paired arms, but also with the variegated first and second branches. Nevertheless, in marked contrast to this pair of symmetrically arrayed, three-sided arms and the main stem's three-sided end which extends just past them, the first and second branches, at their juncture with the main stem, fork away from each other in a noticeably asymmetrical fashion, giving rise to an open-ended passageway. The latter is lined with four partly circular niches, with the niches in each contiguous pair being separated from each other by a tiny offshoot of either the first or second branch.

Distal from the main stem's juncture with the first and second branches, a short section of an elongated strip of a modern acrylic adhesive tape—one which is preferably as wide in its transverse width as is the main stem—is affixed to the latter's three-sided end and extends longitudinally therefrom, forming a free end made to be temporarily stuck to the inside surface of the banjo's rim. Moreover, the strength of the free end's adhesive bond with the rim is more than adequate to keep the thick piece of paper with its three-sided arms, main stem and variegated branches, together with the paired staples and the thin strip of metal attached to them, in a suspended state, provided the free end is long enough and made to stick thoroughly to the underside of the rim's inside surface. Testing has shown that a short segment of this tape, approximately 1¼ inch in length, placed in-line with the inside circumference of the banjo's rim is all that is necessary to capture a significant quantity of a banjo's sound surface waves. Moreover, by positioning the segment so placed in such a way that it traverses portions of the rim's inside surface that are disposed uppermost as the banjo is being played, the installer can insure that the surface waves so captured are transmitted, via the main stem's three-sided end, to the rest of the thick piece of paper as it hangs, from the free end, suspended within the banjo's pot.

Experiments to determine which of the two possible orientations of the free end, so placed in-line with the rim's circumference, produces the best sound have also been conducted. The applicant found that the quality of sound produced is clearly superior when the free end is oriented so as to cause the first branch, to which the thin strip of metal is hingedly connected, to face away from the banjo head and not, as in the other possible scenario, be brought close to this head.

Made of an easily deformed, flexible cardstock across which sound surface waves are known to travel, the thick piece of paper further defines a center hole located on the main stem's longitudinal centerline where it intersects an imaginary line bisecting the two three-sided arms—that is, on a section of the main stem which forms a bridge between the two three-sided arms. As verified by experiment, this center hole substantially increases the degree of amplification that sound surface waves receive as they travel enroute from the banjo's rim, via the free end's interface with the main stem's three-sided end, across the bridge and onto the rest of the main stem and its appendages. Such a result is consistent with the theory that sound surface waves have greater amplitudes as they travel along edges of any kind.

Indeed, most of the several components of the improved sound-enhancing device .abound in edges which are oriented with respect to each other in ways that take advantage of constructive interference, a physical phenomenon. As is well known, the latter adds together the intensities/amplitudes of waves of the same or similar frequencies when they meet, in phase, coming from different directions in the aftermath of each such wave having been reflected off of an edge that exists at the boundary between different media, such as that between cardstock and air, metal and air, or metal and cardstock. Waves with different frequencies, on the other hand, pass through each other unaffected.

Contributing to the effectiveness of the main stem's center hole as an amplifier of high frequency sound surface waves such as those analogous to a note's harmonics are the right-angled corners which the symmetrically-arrayed, three-sided arms form with the main stem. Because, unlike high frequency sound surface waves, their low frequency counterparts diffract or bend onto such laterally extending arms, the latter waves assume trajectories which cause them to concentrate at the arms' far edges. There, spaced apart from the center hole, the low frequency waves increase in amplitude because of the boundary effect and, in so doing, set the far edges in vibration, moving air masses adj acent thereto. The high frequency sound surface waves, on the other hand, tend to travel or flow over the main stem's bridge where, except for the presence of the center hole and its circular edge shown to cause a substantial increase in the waves' amplitude, such waves would traverse the bridge virtually unaffected.

As it is, the amplified high frequency sound surface waves then continue downwardly, along the main stem, enroute to the four partly circular niches and the three tiny offshoots which separate them. When the sound surface waves encounter these tiny offshoots, they vibrate, moving the air adjacent to them and creating air pressure waves of audible sound analogous to the sound surface waves on these offshoots. Because they are very small and the lengths and widths of their respective cantilevers into the open-ended passageway between the first and second branches are very short, the applicant believes that these offshoots vibrate at very high rates and, in so doing, transfer harmonic frequencies to the air within the banjo's pot, thus noticeably improving the instrument's sound quality.

Unlike the high frequency sound surface waves which travel straight-line routes from one edge to the next—routes which in the case of the improved sound-enhancing device direct them down the main stem's longitudinal centerline onto both the partly circular niches' and their offshoot neighbors' edges, the lower frequency sound surface waves tend to diffract or bend as they encounter a corner, along the periphery of the medium across which they are moving—specifically, a corner such as occurs at the main stem/second branch juncture where two of the cardstock's edges meet at an obtuse angle.

Once diffracted or bent onto the second branch, the lower frequency sound waves not only travel a pathway substantially greater in transverse width than is the main stem, but also encounter the pair of staples fastened to this branch crosswise of its through centerline. Remarkably, each such staple, fastened in such a way that the staple's two points are in close proximity to each other and in firm contact with the material stapled, presents edges along which a sound surface wave, traversing the branch, can amplify itself. Here the material stapled is understood to be the thick piece of paper of which the branch is an integral part. To accomplish this feat, the surface wave enters, from the back face of said paper, both of the staple's points at essentially the same time, creating dual wavefronts which then flow over the staple's steel body to the paper's front face where they meet on the staple's flat midsection and amplify by constructive interference. Since the staple's flat midsection is in direct contact with the front face, the amplified sound surface wave flows onto it.

Preferably, the two staples which make up the pair fastened to the second branch are both aligned in parallel and disposed in very close proximity to each other, thus enabling the same process to occur virtually simultaneously in both staples. With the two staples so arrayed, the amplified sound surface waves from the two staples are amplified again as they meet, in phase, at various locations on the paper's front face. Moreover, testing has shown that the amplification provided by these closely-coupled staples is superior to that provided by either a single staple or by three or more aligned in parallel with each other. A further advantage of deploying two staples on the second branch as opposed to none or just one is the fact that the weight of the two staples in combination with the second branch's relatively large transverse width makes this two staple-bearing branch ideally suited for moving adjacent air masses at lower musical frequencies.

Notwithstanding how little the semblance of the first branch has in common with that of the second branch, each of these branches, in assembled relation with at least one attachment in the form of a thin, elongated member formed of metal or the like, presents one or more edges which extend crosswise of the branch's through centerline where a sound surface wave, otherwise traveling across the branch's cardstock or the like thick paper body, not only encounters these edge(s), but also enters the elongated member through them. In the case of the staples fastened to the second branch, such access is made possible when each staple's points firmly press against said body. Where a thin metal strip in the shape of an irregular five-sided polygon is hingedly connected, along its longest edge, to the first branch, such access is achieved with the use of a short segment of acrylic adhesive tape. This segment, acting as both a hinge and a sound surface wave transfer bridge, extends longitudinally along said longest edge's full length affixed simultaneously thereto and to the first branch's body.

Importantly, in the latter case, the five-sided, thin strip of metal or the like, also known as a timbre polygon, is shaped and sized to match the first branch at its terminal end. This match is one in which four of the polygon's edges can be aligned with the terminal end's edges at the same time the polygon's longest edge fully spans the first branch at its greatest transverse width. With their respective edges so aligned and with the polygon's longest edge hingedly connected to the first branch, it and this timbre polygon present a pair of facing surfaces onto which sound surface waves flow simultaneously.

Transfer of sound surface waves from this pair of facing surfaces to the banjo pot's air occurs when the waves' otherwise minute movements have been amplifed sufficiently, through constructive interference on each of these paired surfaces, to compress the air in the smallest spaces between them and, in so doing, form an air pressure wave. Analogous to the manner in which divergent surfaces within a loudspeaker respond to an air pressure wave, the angle at which the timbre polygon is inclined with respect to the first branch's terminal end increases, in a direction away from the polygon's longest edge, so that the facing surfaces can accommodate the air pressure wave as it grows to fill the diverging air space between them and produces audible sound.

### BRIEF DESCRIPTION OF THE DRAWINGS

FIG. 1 is an inside perspective view of the sound enhancing device according to the present invention, the device being depicted as it hangs, suspended within a banjo's pot, from the banjo's rim by an elongated strip of adhesive tape in such a way that the device's first branch and a timbre polygon hingedly connected thereto face away from the banjo's head, with the pot, rim and head being shown as fragments for illustrative purposes only and forming no part of the claimed invention.

FIG. 2 is a partially exploded view, on an enlarged scale, of the sound enhancing device according to FIG. 1, in which only fragments of the elongated strip of adhesive tape that are located on either side of its midsection (not shown) can be seen, with one of them including an end portion of the strip affixed to the device's two dimensional, cut-from-cardstock body, and wherein the timbre polygon is shown unhinged from the first branch, but with a second piece of adhesive tape attached to the polygon that forms a cantilever over the polygon's longest edge, so that the second piece of adhesive tape, in assembled relation with the first branch, can act as a hinge.

FIG. 3 shows an alternate embodiment of the sound enhancing device according to FIG. 2, which, except for the cut-from-cardstock being partially laminated, across a substantial portion of its front face, with clear adhesive packaging tape, is otherwise the same as the one depicted in FIG. 2.

FIG. 4 shows the back face of the device according to FIG. 2, but without the timbre polygon unhinged from said branch.

FIG. 5 is a schematic in which is depicted the typical trace of a sound surface wave as it traverses an enlargement of the five-sided timbre polygon and is reflected multiple times from its edges, with the circles denoting amplifying intersections where the wave undergoes constructive interference.

FIG. 6 is a graphic record of a note's waveform generated by exciting the G-string of a resonator banjo with an e-bow, employing a tuning clip to capture the waveform's signal, and then using the oscilloscope function of Peterson StroboSoft software to display this signal, with this test being conducted prior to the installation of the sound enhancing device according to FIG. 1 within the banjo's pot.

FIG. 7 is a graph on which is recorded an analysis of the overtones present in the note generated and captured as described in FIG. 6, wherein said analysis was performed by running the spectrum analyzer function of said software.

FIG. 8 is a graphic record of a note's waveform generated by exciting the G-string of said resonator banjo, with the waveform being so generated, as well as captured and displayed, in the same manner as was used in carrying out the test described in FIG. 6, but with the waveform shown in FIG. 8 being generated while the sound enhancing device according to FIG. 1 was installed with the banjo's pot.

FIG. 9 is a graph on which is recorded an analysis of the overtones present in the note generated and captured as described in FIG. 8, wherein the analysis was performed by running the spectrum analyzer function of the Peterson StroboSoft software.

### DETAILED DESCRIPTION OF THE PREFRRED EMBODIMENTS

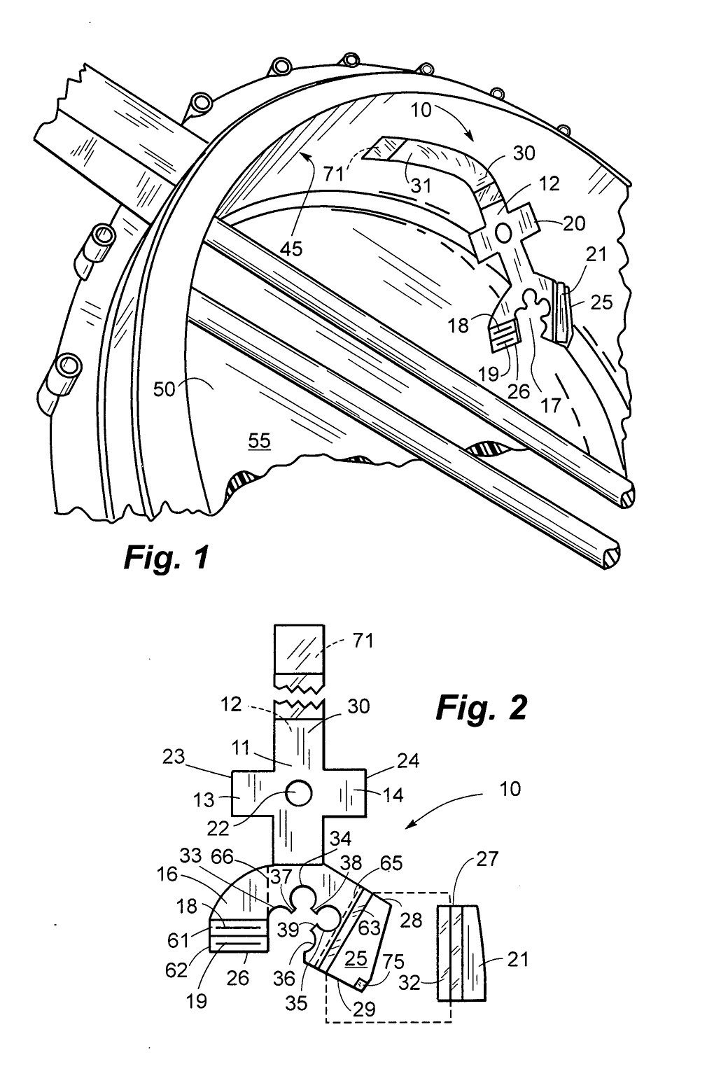

In the drawings, an improved tone amplifier for use with a banjo having a cylindrical rim 45 that encircles the banjo's pot 50 is indicated generally by the reference numeral 10. The amplifier 10 includes a two dimensional, paper thin body 20 cut out of easily deformed, flexible cardstock or the like, at least one timbre polygon 21, a pair of staples 18, 19, and an elongated, acrylic adhesive tape segment 30, part of which is permanently affixed to the body's three-sided end 12. Prior to operation, the body 20 is suspended, within the banjo pot 50, by sticking the tape segment's free end 31 to the uppermost portions of the rim's inside surface (FIG. 1).

Incorporated within the tone amplifier's design are many routes for sound surface waves to travel, whether they are transferred, via the adhesive tape segment 30, from the banjo's cylindrical rim 45 onto the amplifier's three-sided end 12, or are created upon impact as its body 20 is exposed to air pressure waves (audible sound) within the banjo pot 50. Because of constructive interference-related spatial differences in the intensity of the air pressure waves from point to point within the pot 50, whatever the latter of these two energy transfer modes may contribute to the tone amplifier's output is strongly dependent upon the orientation of the body 20 with respect to the banjo's head 55. Indeed, the best sound, according to experimental findings, is produced when this two-dimensional body's planar face is oriented perpendicularly to the head 55 rather than in parallel with it. Moreover, such a superior sound requires that the amplifier's timbre polygon 21 be spaced well apart from the banjo head 55 when the body's planar face is thus perpendicularly oriented.

With the timbre polygon 21 hingedly connected to the body 20 at a site on it located off-center of the body's main stem, the necessary spacing between the timbre polygon and the banjo head 55 is achieved by simply choosing, from among two possible orientations in which the tape segment's free end 31 can be placed in-line with the rim's circumference, the one which causes the timbre polygon to face away from the banjo head and not be brought close to it (FIG. 1).

Common to at least the initial leg of the many routes that sound surface waves travel across the body 20, once these waves have been transferred onto it through the acrylic adhesive tape segment 30, is the elongated main stem 11. Appendages to this main stem, which, like it, are formed as integral parts of the amplifier's body 20, include first and second branches 15, 16 and a pair of symmetrically arrayed, three-sided arms 13, 14 (FIGS. 2 and 4).

As is characteristic of appendages onto which low frequency sound surface waves tend to diffract or bend, the laterally extending arms 13, 14 form right-angled corners with the main stem 11 and terminate in parallel far edges 23,24, respectively. There the diffracted waves grow in intensity, causing the edges 23,24 to vibrate. The rest of the sound surface waves, on the other hand, either flow around or onto a center hole 22. Located on the main stem 11 itself and approximately equidistant from each of the three-sided arms' rightangled corners, the center hole 22 presents an edge along which those waves which remain in transit on the main stem are themselves amplified.

Upon reaching the main stem's intersection with the first and second branches 15, 16, the lower frequency sound surface wavefronts once again tend to diffract or bend and, in so doing, spread out onto yet another set of main stem appendages. Left to travel straight ahead, the high frequency sound surface waves, as well as the undiffracted components of their lower frequency counterparts, are routed toward an asymmetrical array of partly circular, recessed edges 33-36 and tiny offshoots, in which the recessed edges in each contiguous pair 33, 34; 34, 35; 35,36 are separated from each other by an offshoot 37, 38, 39, respectively. Individually, the offshoots 37- 39 project outwardly into an open-ended passageway 17(FIGS. 2 and 4). The latter is lined along a substantial portion of its periphery with niches defined by the recessed edges 33-36. Indeed, even at the passageway's mouth, a recessed edge 36 on the first branch's side opposes a straight-edged one on the second branch's sharp-cornered terminal end 26 for most of said end's length (FIG. 2). With the recessed edge 36 and the terminal end 26 so opposed, the first branch's terminal end 25, along with the timbre polygon 21 hingedly connected thereto, is positioned to veer away from the second branch 16 altogether and produce sound at a higher quality than would otherwise is achieved.

Construction of the amplifier's body 20, preferably fabricated, as a single piece, from 67 pound Neenah Paper® Premium Exact Vellum Bristol cardstock with a semi-smooth finish, entails punching four i inch diameter holes in it, each of them individually centered on a corner of an imaginary square which measures approximately 5/16 inch by 5/16 inch. So centered, the holes are not tangent, but rather offset by 1/16th of an inch from each other—the width of each tiny offshoot 37-39 at its tip.

Moreover, when the construction of the body 20 is complete, the fragments 33-36 of the four holes' annular edges still retain the same basic orientation as that which the square's four corners exhibited with respect to the main stem 11 and its appendages. Specifically, the orientation retained by these four fragments is one in which two of the square's corners that oppose each other across one of its diagonals are intersected by the same imaginary straight line which passes through the center of the main stem's hole 22 (FIGS. 2 and 4). The latter is yet another punched, ¼ inch diameter hole in the amplifier's body 20.

While each tiny offshoot 37-39 is sized to vibrate at the very high frequencies of short wavelength sound surface waves, the second branch 16 and its sharp-cornered terminal end 26 are not. Preferably differing in its transverse width from that of each tiny offshoot's tip by an order of magnitude, the terminal end 26 presents multiple edges along which lower frequency/longer wavelength sound surface waves can travel and, in so doing, gain in amplitude as two such waves at the same or similar frequencies meet each other in phase at one of these edges.

Contributing to the number of such edges is a pair of staples 18, 19 fastened to the second branch 16 in such a way that each staple's two points are in firm contact with the body's back face 60 (FIGS. 2 and 4). Swingline S.F. 4 premium staples chisel point, which are available commercially, have been proven to satisfy this requirement and otherwise serve as a preferred attachment to the amplifier's body 20. As is illustrated in FIG. 2, the staples 18, 19 are not only aligned in parallel with each other and with one of the terminal end's own edges, but also each staple extends crosswise of the terminal end's through centerline, nearly spanning said end's transverse width. In the preferred embodiment, the two staples 18, 19 are separated from each other by approximately ⅛th of an inch, whereas the distance between the staple 19 and each of the three edges which make up the terminal end's periphery is only about 1/16th inch. Also preferably included are two narrow boxes 61, 62, printed in outline on the terminal end 26, to serve, during the tone amplifier's assembly, as guides for properly spacing the staples 18, 19 apart from each other, as well as relative to the terminal end's edges (FIG. 2).

Out of the four partly circular edges 33-36 which, in combination with the offshoots 37-39, line a substantial portion of the open-ended passageway's periphery, all but one of said edges is at least partly located on the first branch's side of its boundary with the passageway 17. Moreover, when the timbre polygon 21, in assembled relation with the first branch 15, is hingedly connected thereto, points on the partly circular, recessed edge 35 are situated in such close proximity to the timbre polygon's longest edge 27 that the distance between it and said points measures only about ⅛ inch (FIG. 2).

Serving a dual function in this timbre polygon/first branch assembly as both a hinge and a sound surface wave transfer bridge is a short, acrylic adhesive tape segment 32. In the preferred embodiment, tape segment 32 is a separate piece of the same material as is tape segment 30: specifically, 3M™ 600 Clear Acrylic Tape (Scotch® High Gloss Tape). Testing has confirmed that this acrylic adhesive backed tape easily captures sound surface waves. Nevertheless, the relative positions of not only the timbre polygon's longest edge 27 and the recessed edge 35, but also the short tape segment 32 and said recessed edge matter. This is especially true in the case of the amplifier 10, designed as it is to maximize the likelihood that a high frequency sound surface wave traveling across its body 20 will gain access to the timbre polygon 21 through it longest edge 27.

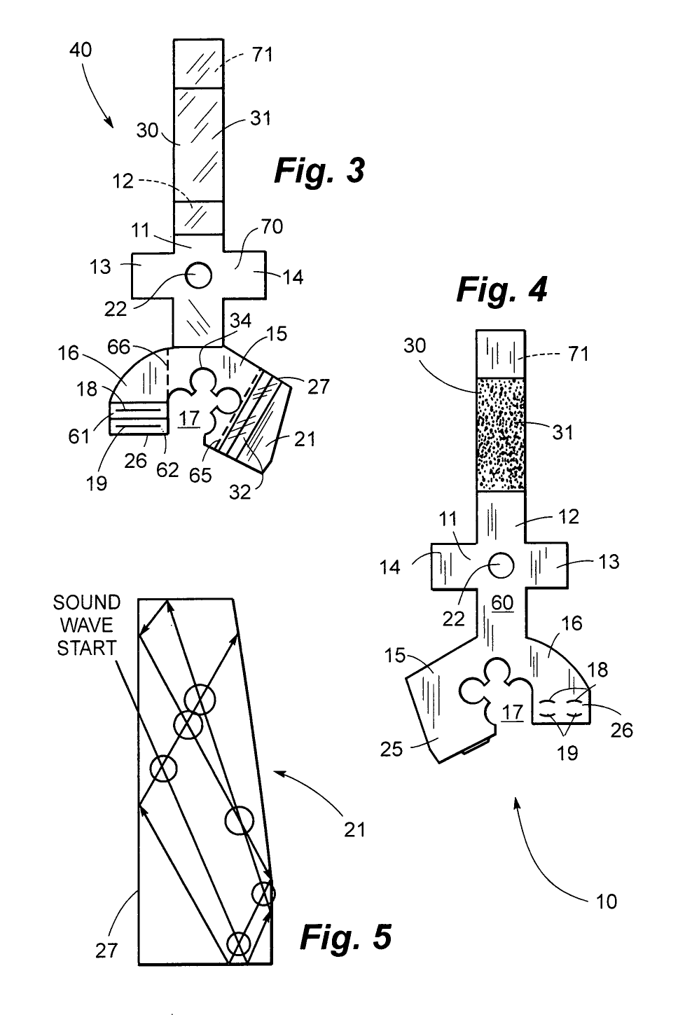

In assembled relation with the timbre polygon 21, the tape segment 32, while in a longitudinally extended state, is affixed to the longest edge 27 in such a way that about one-half of the tape segment's transverse width is cantilevered over it (FIGS. 2 and 3). Of use as a guide to properly attaching the timbre polygon 21 to the first branch 15 by way of adhering that portion of the tape segment 32 so cantilevered is an unbroken boundary line 63 and a first dashed line 65 in parallel therewith, both of which are printed on the amplifier's body 20 (FIG. 2). The optimum configuration for such an attachment is one in which four of the polygon's edges—specifically, those shaped and sized so as to match the first branch's at its terminal end 25—are aligned with the latter edges at the same time the polygon's longest edge 27 is not only aligned in parallel with the boundary line 63, but also contiguous therewith and hence, like it, is oriented perpendicularly to the first branch's two parallel edges 28,29.

The construction of the timbre polygon/first branch assembly further entails affixing an angle stop 75 to the terminal end 25. As illustrated in FIG. 2, a suitable angle stop 75, fabricated from 1/16th inch thick foam tape and measuring approximately ⅛th×⅛th inch square, is mounted on the cardstock body 20 so that, in assembled relation, the angle stop is juxtaposed between the terminal end 25 and the timbre polygon 21. So mounted, the square-shaped angle stop's first and second sides are preferably disposed contiguous with the parallel edge 29 and with the first branch's terminal edge disposed perpendicularly thereto, respectively (FIG. 2).

Instead of a rectangle or a like regular polygon, one with the five-sided, irregular shape of the timbre polygon 21 is preferred because the latter presents an array of edges which has been proven to dramatically increase the amplification of sound surface waves transferred, via the tape segment 32, from the first branch 15 onto the timbre polygon itself. For example, as depicted schematically in FIG. 5, an eight-fold crisscrossing of the five-sided polygon 21, in which a typical high frequency sound surface wave, traveling in a straight-line from one edge to the next, is reflected off of the polygon's various edges a total of seven times, yields six intersections at which the sound surface wave, through constructive interference amplifies itself. Remarkable feats of this nature—not only simultaneously duplicated on the timbre polygon-facing surface of the terminal end 25, but also occurring at the same time the hinged connection between said end and the polygon 21 positions their respective facing surfaces in such a way that a diverging air space is formed therebetween—are believed to account, in large part, for the prominence which high frequency harmonics/overtones have in that portion of a banjo's notes attributable to an amplifier 10 installed within the banjo's pot 50.

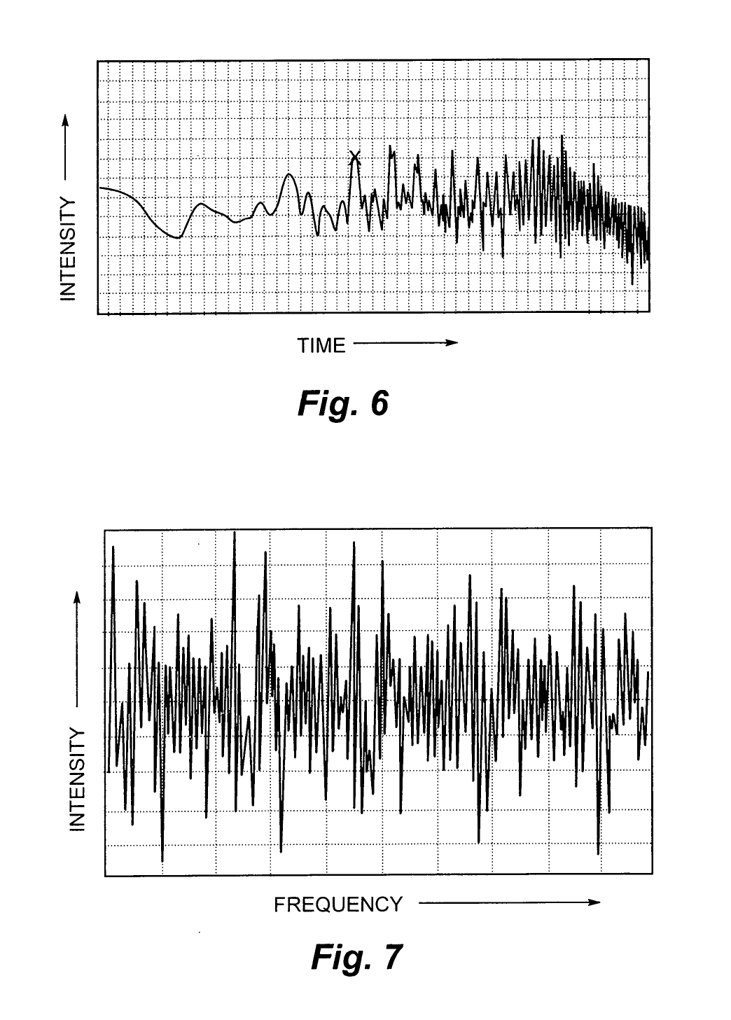

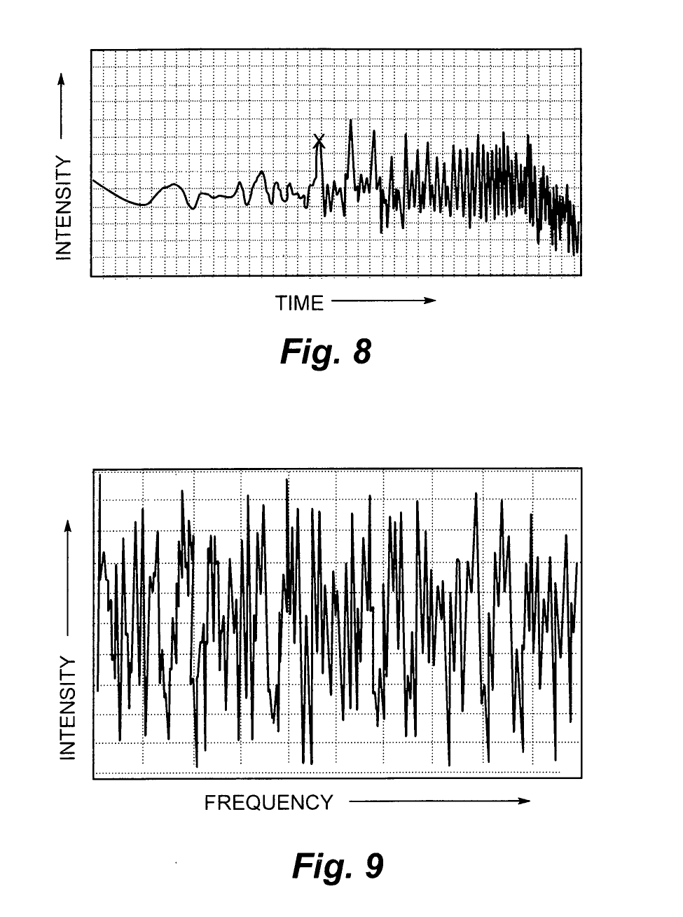

In the case of a resonator banjo, the differences in the sound of its G-string as it was being played prior to the installation of the amplifier 10 within the banjo's pot 50 and while the amplifier was so installed are displayed graphically in FIGS. 6-7 and 8-9, respectively. These graphs first appeared in print in Bango Newsletter, Vol. XLIV-8, p. 4 (June 2017). A pronounced increase in high frequency, audible sound waves which accompanies said installation of the amplifier 10 is apparent when one compares the analysis recorded in FIG. 9 with that shown in FIG. 7.

The timbre polygon 21 is typically fabricated of thin carbon steel and measures approximately 0.007 inch in thickness. One inch is the approximate length of the polygon's edge 27. Running perpendicular to it and parallel to each other are two edges, one of which is approximately inch long and the other approximately ⅜ inch long. The lengths of of the polygon's remaining two edges, one of which intersects said ¼ inch long edge and the other of which intersects the ⅜ inch long edge, are approximately 0.76 inch and ¼ inch, respectively. Timbre polygons 21 fabricated of brass or, alternately, maple veneer measure approximately 0.010-inch and 1/32 inch in thickness, respectively, but otherwise have the same dimensions as the steel timbre polygon.

A change in the banjo's timbre or tone “color” can be easily achieved by replacing a timbre polygon 21 made of steel, for example, with an identically shaped one made of brass or of maple veneer or vice versa. Indeed, each such replacement polygon is preferably pre-taped along its longest edge 27 with its own tape segment 32, properly cantilevered over said edge for attachment to the first branch 15 once any timbre polygon 21 already in place there has been removed. Alternately, such a timbre polygon 21 can form a base on which one or more timbre polygons, possibly each of a different material, are stacked. Not surprisingly, as each additional timbre polygon 21 is so stacked, yet another pair of facing surfaces is created and with it one more diverging air space, thus further increasing the volume of sound in the amplifier's output.

Changes in both the banjo's volume and sound quality which result in an exceptionally beautiful sound can also be achieved by transforming the two-dimensional cut-from-cardstock body 20 into a three-dimensional array which defines three distinct planar surfaces oriented with respect to each other in such away that audible sound outputs from the tone amplifier 10 which would otherwise not intersect in air do so and, as a consequence, undergo constructive interference. By simply bending the cut-from-cardstock body 20 along first and second dashed lines 65, 66, printed on the first and second branches 15, 16, respectively, while simultaneously taking care to position one of said three planar surfaces between the other two so that both of the latter extend in generally the same direction away from it, a banjo player can readily transform the two-dimensional body 20 into the three-dimensional array. The optimum angle at which each of the two planar surfaces is so extended varies markedlyfrom one planar surface to the other and may be dependent upon the individual banjo as well. A configuration which the applicant has found works especially well in the case of his own banjo is that in which one of the planar surfaces so extended—in particular, the one formed when a substantial portion of the second branch, including its terminal end 26 and the staples 18, 19 attached thereto—is bent along the dashed line 66 at a 90-degree angle with respect to the planar surface so positioned, at the same time the other planar surface so extended—in particular, the one formed when a substantial portion of the first branch 15, including its terminal end 25 and the timbre polygon 21 attached thereto—is bent along the dashed line 65 through an angle of only 30-degrees with respect to the planar surface so positioned.

Illustrated in FIG. 3 is an alternate embodiment 40 of the improved sound enhancing device which, like the amplifier 10, has a body 20 to which is affixed a narrow, clear packaging tape segment. Sized to cover only that area of the body 20 which lies between the unbroken boundary line 63 and the dashed line 65 on the first branch 15, this narrow tape segment is used to protect the body's front face from minute tears and the like which might otherwise accompany detachment of the cantilevered portion of acrylic adhesive tape segment 32 as the latter is being pulled free of the body 20 during a timbre polygon's replacement.

Differing widely in shape and size from the narrow tape segment that is common to both embodiments 10, 40 is a much larger, clear packaging tape section 70. Nevertheless, it, like the narrow tape segment, is preferably cut from a piece of 3M™ Scotch® High Performance Packaging Tape. Laminated onto the body 20 of the amplifier 40, the tape section 70 extends across the body's front face from the three-sided end 12 to an imaginary line which connects points on the main stem 11 that are located at the intersections between its opposing side edges and the first and second branches 15,16, respectively, wherein the tape section 70 defines a straight edge that both follows said imaginary line and spans the distance between said opposing side edges. Moreover, the tape section 70 does not cover either the main stem's central hole 22 or that part of the acrylic adhesive tape segment 30 which is permanently affixed to the three-sided end 12.

Acting primarily as a moisture barrier for a substantial portion of the amplifier's front face, the tape section 70 has also been found to improve the quality of the high tones which the amplifier 40, once its first and second branches 15, 16 have been bent to form the three-dimensional array with the 30-degree/90-degree configuration described hereinabove, produces as compared to its sound output when the body's front face is laminated with a longer clear packaging tape section (not shown)—specifically, one that covers the front face from the three-sided end 12 to an imaginary line tangent to the partly circular, recessed edge 34.

As is also illustrated in the drawings, a small, nonsticky tab 71 is affixed to the distal end of each tone amplifier's tape segment 30 (FIGS. 1 through 4). The tab 71 is provided to facilitate placement of the tape segment 30 on the inside surface of the banjo's cylindrical rim 45, preferably once any dust on it has been removed with a clean cloth or the like, as well as to make it easier for one to move said tape segment from one attachment site to the next within the banjo pot 55 or, alternately, to transfer the amplifier 10,40 from one banjo to another.

What is claimed is:

1. A sound enhancing device adapted for use with banjos having a head and a support member therefor which, in assembled relation with each other, define a generally cylindrically shaped sound chamber, wherein the support member includes a cylindrical rim with an inside surface that is substantially as wide as the sound chamber is deep, which comprises:
(a) a one piece body cut from cardstock, the body defining a main stem and first and second branches, each of which forks away from the other at the branches' juncture with the main stem in such a way as to form an open-ended passageway; wherein the one piece body further defines four partly circular, recessed edges and three tiny offshoots of said branches which are arrayed, along a substantial portion of the open-ended passageway's periphery, in such a way that the partly circular, recessed edges in each contiguous pair thereof are separated from each other by one of the tiny offshoots, with each of the offshoots, as it projects away from such a contiguous pair's recessed edges and into the passageway, being oriented perpendicularly with respect to at least one of the other offshoots; and
(b) means, including an elongated strip of adhesive tape, parts of which are variously affixed to the main stem and, during the device's operation, to the banjo's cylindrical rim, for suspending the one piece body from portions of the rim's inside surface which are disposed generally uppermost when the banjo is being held in its playing position.

2. The device according to claim 1, wherein the first and second branches are further characterized as defining first and second angular terminal ends, respectively, with the latter terminal end having, as one of its lateral sides, a straight edge that both runs generally parallel to the main stem's through centerline and faces one of the partly circular, recessed edges lining the passageway on the first branch's side at the passageway's mouth; and wherein the first angular terminal end's lateral side in closest proximity to said mouth veers away therefrom, so that the first angular terminal end is kept free of any overlap between its periphery and that of the open-ended passageway.

3. The device according to claim 2, which further comprises a pair of staples, each of which is fastened to the second angular terminal end and held in firm contact therewith, wherein the staples so fastened are aligned in parallel with each other and only narrowly spaced apart, with each staple extending crosswise of the second angular terminal end's through centerline and nearly spanning said end's. transverse width.

4. The device according to claim 1, which further comprises a timbre polygon having at least one long, straight edge and means, including an adhesive tape segment affixed to the polygon along said straight edge, with about one-half of the tape segment cantilevered over it and extending generally parallel thereto, for hingedly connecting the timbre polygon to the first branch proximate with its terminal end, wherein the respective edges of the timbre polygon and of the first branch's terminal end are further characterized as being so shaped and sized that said straight edge can be oriented perpendicularly with respect to two of the first branch's edges while it simultaneously spans the distance between them, with the straight edge being so oriented at the same time at least three other edges on the polygon are aligned with a like number of edges bounding the first branch at its terminal end, so that the timbre polygon and the first branch's terminal end, in assembled relation, form a pair of facing surfaces which match each other in shape and size with their respective edges distal from said straightedge's interface with the first branch being spaced apart, thus creating a diverging air space between the facing surfaces.

5. The device according to claim 4, wherein the timbre polygon is further characterized as being an irregular, five-sided polygon.

6. The device according to claim 4, wherein the timbre polygon's long, straight edge over which about one-half of the tape segment is cantilevered is located in such close proximity to one of the partly circular, recessed edges so arrayed along the open-ended passageway's periphery that the tape segment's cantilevered one-half abuts the recessed edge at points thereon disposed approximately midway between said two edges of the first branch that are oriented perpendicularly with respect to the polygon's long, straight edge.

7. A sound enhancing device adapted for use with banjos having a head and a support member therefor which, in assembled relation with each other, define a generally cylindrically shaped sound chamber, wherein the support member includes a cylindrical rim with an inside surface that is substantially as wide as the sound chamber is deep, which comprises:
(a) a one piece body cut from a thick piece of paper, the body defining a main stem and first and second branches with variegated first and second angular terminal ends, respectively, wherein each of the branches forks away from the other at the branches' juncture with the main stem so as to form an asymmetricalarray with an open-ended passageway, the mouth of which is bounded on one side by one of the second angular terminal end's lateral side edges at the same time the first angular terminal end's lateral side edge in closest proximity to said mouth veers away from it, so that the first angular terminal end is kept free of any overlap between its periphery and that of the open-ended passageway; and
(b) means, including an elongated strip of adhesive tape, parts of which are variously affixed to the main stem and, during the device's operation, to the banjo's cylindrical rim, for suspending the one piece body from portions of the rim's inside surface which are disposed generally uppermost when the banjo is being held in its playing position.

8. The device according to claim 7, which further comprises a timbre polygon having at least one long, straight edge and means, including an adhesive tape segment affixed to the polygon along said straight edge, with about one-half of the tape segment cantilevered over it and extending generally parallel thereto, for hingedly connecting the timbre polygon to the first branch proximate with its angular terminal end, wherein the respective edges of the timbre polygon and of the first angular terminal end are further characterized as being so shaped and sized that said straight edge can be oriented perpendicularly with respect to two of the first branch's edges while it simultaneously spans the distance between them, with the straight edge being so oriented at the same time at least three other edges on the polygon are aligned with a like number of edges bounding the first branch at its angular terminal end, so that the timbre polygon and the first branch's angular terminal end, in assembled relation, form a pair of facing surfaces which match each other in shape and size with their respectives edges distal from said straight edge's interface with the first branch being spaced apart, thus creating a diverging air space between the facing surfaces.

9. A method for enhancing the sound of banjos having a head and a support member therefor which, in assembled relation with each other, define a generally cylindrically shaped sound chamber, wherein the support member includes a cylindrical rim with an inside surface that is substantially as wide as the sound chamber is deep, which includes the steps of:
(a) bending a one piece body cut from a thick piece of paper into a three-dimensional array, the unbent body defining a main stem and first and second branches with variegated first and second angular terminal ends, respectively, wherein each of the branches forks away from the other at the branches' juncture with the main stem so as to form an asymmetrical array with an open-ended passageway, the mouth of which is bounded on one side by one of the second angular terminal end's lateral side edges at the same time the first angular terminal end's lateral side edge in closest proximity to said mouth veers away from it;
(b) wherein the three-dimensional array defines first, second and third planar surfaces, each of which is intersected at least one of the other two planar surfaces, with the third planar surface being juxtaposed between the first and second planar surfaces, both of which extend in generally the same direction away from the third planar surface;
(c) wherein the first planar surface, which comprises most of the first angular terminal end, intersects the first angular terminal end's lateral side edge in closest proximity to said mouth, with the first planar surface's bend with the third planar surface, as said bend extends perpendicularly to the latter lateral side edge, being kept generally free of contact with the open-ended passageway's periphery;
(d) wherein the second planar surface, which comprises most of the second angular terminal end including said lateral side edge which bounds the mouth of the open-ended passageway, is disposed generally perpendicularly with respect to the third planar surface at the same time the first planar surface is inclined away from the second planar surface and the first and second planar surfaces diverge from each other as they extend, each along its respective bend with the third planar surface, in the direction of the branches' juncture with the main stem; and
(e) suspending the three-dimensional array from portions of the rim's inside surface which are disposed generally uppermost when the banjo is being held in its playing position, with the array being so suspended by an elongated strip of adhesive tape, parts of which are variously affixed to the main stem and, during the array's operation, to the banjo's cylindrical rim.
